(19) United States
(12) Patent Application Publication
(10) Pub. No.: US 2025/0245743 A1
(43) Pub. Date: Jul. 31, 2025

(54) AI DRIVEN EXPERT AND INVESTOR COLLABORATIVE SYSTEM

(71) Applicant: Cyrannus Inc., New Albany, OH (US)

(72) Inventors: Howard Lee Mosbacker, IV, New Albany, OH (US); Mikhail Arbuzov, New Albany, OH (US)

(21) Appl. No.: 19/037,749

(22) Filed: Jan. 27, 2025

Related U.S. Application Data
(60) Provisional application No. 63/625,569, filed on Jan. 26, 2024.
(60) Provisional application No. 63/677,489, filed on Jul. 31, 2024.

(51) Int. Cl. G06Q 40/04; G06Q 30/0282

(52) U.S. Cl. CPC G06Q 40/04; G06Q 30/0282

(57) ABSTRACT

Methods and systems are described for facilitating knowledge sharing between one or more startups, one or more experts, and one or more investors, and optimizing investment decisions. Embodiments can combine AI/ML with expert opinion in target domains. Embodiments can combine advanced AI tools, including Recommender Systems and Large Language Models, with the expertise of domain specialists and the financial acumen of seasoned investors. Embodiments can streamline the evaluation of investment opportunities, enhances decision-making precision, and aligns investments with market trends and viability. Embodiments can increase accuracy, scalability, and speed of investment decisions by blending AI and collective human perspectives.

### CROSS REFERENCE TO RELATED INFORMATION

This application claims the benefit of United States of America priority application No. 63/625,569 filed on Jan. 26, 2024, titled “AI Driven Expert and Investor Collaborative System,” and United States of America priority application No. 63/677,489 filed on Jul. 31, 2024, titled “AI Driven Expert and Investor Collaborative System,” the contents of which are hereby incorporated herein in its entirety.

### TECHNICAL FIELD

The present disclosure generally relates to systems and methods for artificial intelligence-based enhancements to create interoperability between social networks and investment systems.

### BACKGROUND

Venture capital decisions carry substantial uncertainty, yet rely heavily on human judgment prone to biases. This presents an immense challenge in the startup ecosystem, where the volume of funding applications massively outpaces thorough due diligence. At the same time, judgment is necessary when weighing and distinguishing good investment opportunities versus bad ones. And there are times when aggregated human judgment can prove valuable. It is difficult to weigh aggregated judgments accurately. See, e.g., “Studying the ‘Wisdom of Crowds’ at Scale,” Simoiu et al., available at, https://www.web.stanford.edu/˜csimoiu/doc/wisdom-of-crowds.pdf.

Pre-seed investments require large portfolios: Pre-seed investment returns follow power law distribution with 0.5% reaching unicorn status with ×100 returns and 0.5% reaching deca-corn status with ×500+ returns. For this reason, returns of small pre-seed investment portfolios also follow the power law distribution. To have expected returns that do not follow a power law, the pre-seed portfolio size should be no less than 500 startups.

Large pre-seed portfolios require a way to process startup applications at a large scale. Historically, pre-seed investments are extremely selective, providing 1 to 3 investments out of 100 applications. This means that a portfolio of 500 startups would require a review of 15,000 to 50,000 applications.

Pre-seed startups specializing in highly technical domains can only be reviewed by experts having domain knowledge in the field. The best domain experts are already employed and are extremely hard to find, also having outstanding compensation packages. This calls for a unique solution to make the process feasible by leveraging fractional employment of the experts while deeply optimizing the review funnel.

Certain prior art included two-stage approach reminiscent of recommender systems first introduced by Google research teams for high-load information retrieval and recommendations (Covington. 2016; Cheng 2016). But these were not robust or smart enough for distinguishing between good and bad investments.

Over the past century, there have been dozens of studies that document this “wisdom of crowds” effect. Surowiecki, James, “The Wisdom of Crowds,” Anchor (2005). Simple aggregation—as in the case of Galton's ox competition—has been successfully applied to aid prediction, inference, and decision-making in a diverse range of contexts. For example, crowd judgments have been used to successfully answer general knowledge questions (Id.), identify phishing websites and web spam (see e.g., Moore, Tyler et al., “Evaluating the wisdom of crowds in assessing phishing websites,” International Conference on Financial Cryptography and Data Security, Berlin, Heidelberg, Springer Berlin Heidelberg (2008); Liu, Yiqun, et al. “Identifying web spam with the wisdom of the crowds,” ACM Transactions on the Web (TWEB) 6.1, p. 1-30 (2012)), forecast current political and economic events (see e.g., Budescu, David V., et al., “Identifying expertise to extract the wisdom of crowds,” Management Science 61.2, p. 267-280 (2015); Griffiths, Thomas L., et al., “Optimal predictions in everyday cognition,” Psychological science 17.9, p. 767-773 (2006); Hill, Shawndra, et al., “Expert stock picker: the wisdom of (experts in) crowds,” International Journal of Electronic Commerce 15.3, p. 73-102 (2011)), predict sports outcomes (see e.g., Herzog, Stefan M., et al., “The wisdom of ignorant crowds: Predicting sport outcomes by mere recognition,” Judgment and Decision Making 6.1, p. 58-72 (2011); Goel, Sharad, et al., “Predicting consumer behavior with Web search,” Proceedings of the National Academy of Sciences, 107.41, p. 17486-17490 (2010)), and predict climate related, social, and technological events (see e.g., Hueffer, Karsten, et al., “The wisdom of crowds: Predicting a weather and climate-related event.” Judgment and Decision Making 8.2, p. 91-105 (2013); Kaplan, Abraham, et al., “The prediction of social and technological events.” Public Opinion Quarterly 14.1, p. 93-110 (1950)). A recent study from the University of Stanford analyzing over half a million responses, supports this methodology, showing that collective judgments usually surpass individual decision accuracy. Simoiu, Camelia, et al., “Studying the “wisdom of crowds” at scale,” Proceedings of the AAAI Conference on Human Computation and Crowdsourcing, Vol. 7 (2019). However, they also highlight that effectiveness varies with context, particularly under consensus conditions where seeing others' opinions influences voting, often leading to reinforcement of initial errors.

### SUMMARY

One embodiment under the present disclosure comprises a computer implemented method for facilitating knowledge sharing between one or more startups, one or more experts, and one or more investors, and optimizing investment decisions. The method comprises receiving an application from one or more companies in a startup pool; using AI & ML pipeline to narrow the one or more companies down to one or more startups; matching the one or more startups with one or more experts in a relevant technical field; receiving one or more data from the one or more startups about the one or more startups; transmitting the one or more data to the one or more experts; receiving one or more analyses from the one or more experts of the one or more startups; and aggregating the one or more analyses to create a consensus rating for each of the one or more startups.

Another embodiment under the present disclosure comprises a computer implemented method for training a machine learning model for optimizing investment outcomes. The method comprises obtaining a dataset of identified investment outcomes; training the machine learning model using the dataset of identified investment outcomes thereby obtaining a trained machine learning model, and storing the trained machine learning model.

Another embodiment comprises a system for facilitating knowledge sharing between one or more startups, one or more experts, and one or more investors, and optimizing investment decisions. The system comprises processing circuitry and a memory. The memory contains instructions executable by the processing circuitry whereby the system/apparatus is operative to any of the steps of; receiving an application from one or more companies in a startup pool; using artificial intelligence or machine learning to narrow the one or more companies down to one or more startups; matching the one or more startups with one or more experts in a relevant technical field; receiving one or more data from the one or more startups about the one or more startups; transmitting the one or more data to the one or more experts; receiving one or more analyses from the one or more experts of the one or more startups; and aggregating the one or more analyses to create a consensus rating for each of the one or more startups.

This summary is provided to introduce a selection of concepts in a simplified form that are further described below in the detailed description. This summary is not intended to identify key features or essential features of the claimed subject matter, nor is it intended to be used as an indication of the scope of the claimed subject matter.

### BRIEF DESCRIPTION OF THE DRAWINGS

For a more complete understanding of the present disclosure, reference is now made to the following descriptions taken in conjunction with the accompanying drawings, in which:

FIG. 1 illustrates one embodiment of an AI-enhanced investment social network system under the present disclosure;

FIG. 2 illustrates a process flow for an embodiment under the present disclosure;

FIG. 3 illustrates similarity metrics;

FIG. 4 illustrates embedding models;

FIG. 5 illustrates various possible user interfaces under the present disclosure;

FIG. 6 illustrates various possible user interfaces under the present disclosure;

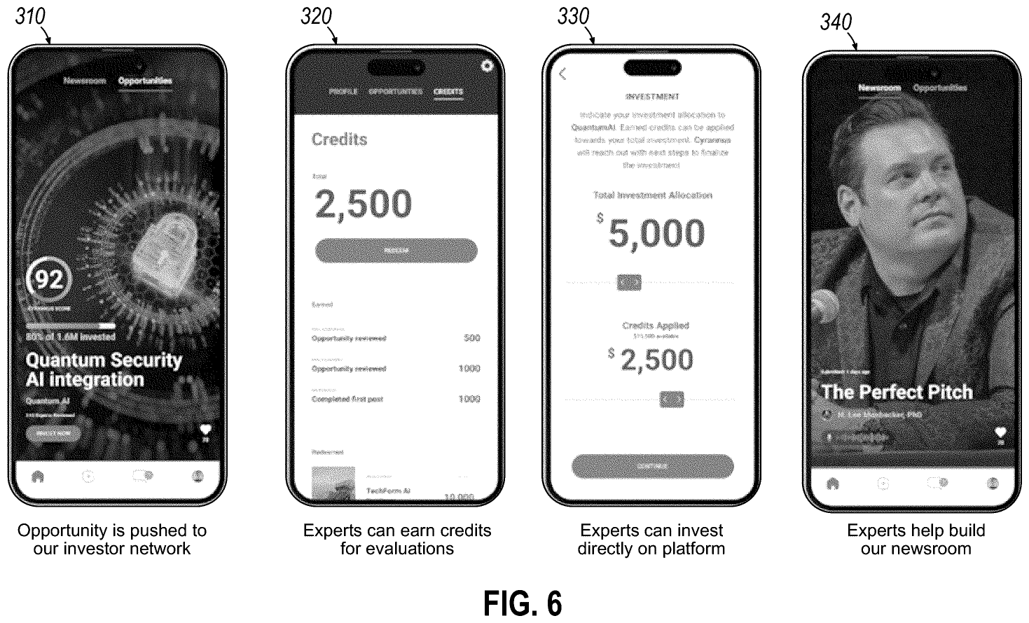

FIG. 7 shows an example flow chart of training and inference pipelines for machine learning in accord with some embodiments under the present disclosure;

FIG. 8 shows an embodiment of a neural network/multi layered perceptron (MLP) under the present disclosure;

FIG. 9 shows an embodiment of a computing device for use in various embodiments under the present disclosure;

FIG. 10 illustrates a flow-chart of a method embodiment under the present disclosure; and

FIG. 11 illustrates a flow-chart of a method embodiment under the present disclosure.

### DETAILED DESCRIPTION

Before describing various embodiments of the present disclosure in detail, it is to be understood that this disclosure is not limited to the parameters of the particularly exemplified systems, methods, apparatus, products, processes, and/or kits, which may, of course, vary. Thus, while certain embodiments of the present disclosure will be described in detail, with reference to specific configurations, parameters, components, elements, etc., the descriptions are illustrative and are not to be construed as limiting the scope of the claimed embodiments. In addition, the terminology used herein is for the purpose of describing the embodiments and is not necessarily intended to limit the scope of the claimed embodiments.

Venture capital is an important driver of innovation in the economy. There currently exist certain challenges. It is difficult to facilitate the sharing of accurate information, expertise in various industries, and facilitating relationships amongst investors, experts, and venture capital targets.

Certain aspects of the disclosure and their embodiments may provide solutions to these or other challenges. Embodiments include a cutting-edge decision-making framework that integrates AI-driven analytics with expert and investor insights to optimize vestment strategies in startups and emerging technologies. It combines advanced AI tools, including recommender systems and large language models with the expertise of domain specialists and the financial acumen of seasoned investors. Embodiments can streamline the evaluation of investment opportunities, enhances decision-making precision, and align investments with market trends and viability. Embodiments under the present disclosure can tackle the described challenges through an inventive human-AI symbiosis. Integrating machine learning with collective human insights, the system streamlines deal flow evaluation. Automated tools curate and analyze data, while diverse panels of domain and business experts provide strategic guidance grounded in real-world experience. The framework incorporates checks and balances, with investor oversight balancing crowd-sourced due diligence.

Certain embodiments may provide one or more of the following technical advantages. Embodiments can effectively balance technological innovation with human expertise for smarter data-drive investment decisions. Embodiments under the present disclosure include cutting-edge decision-making frameworks, systems, and methods that integrates AI-driven analytics with expert and investor insights to optimize investment strategies in startups and emerging technologies. It combines advanced AI tools, including Recommender Systems and Large Language Models, with the expertise of domain specialists and the financial acumen of seasoned investors. Embodiments can streamline the evaluation of investment opportunities, enhances decision-making precision, and aligns investments with market trends and viability. Embodiments can also increase accuracy, scalability, and speed of investment decisions by blending AI and collective human perspectives.

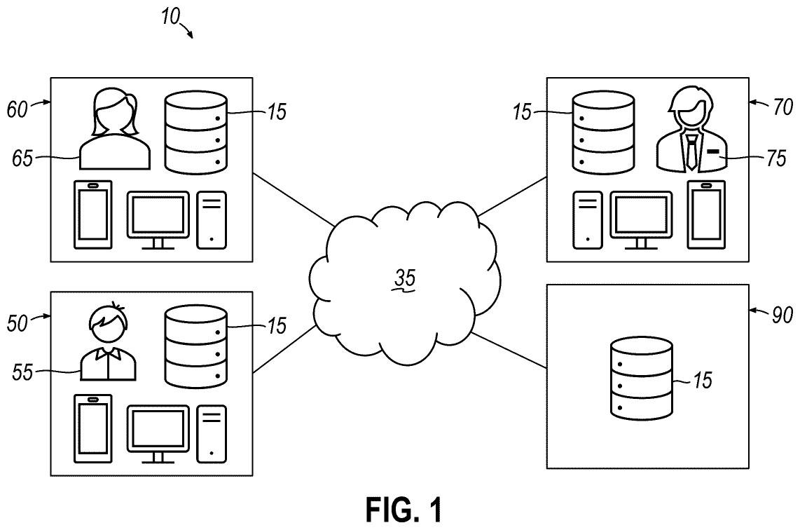

Referring now to FIG. 1, one embodiment of an investor social network system 10 is shown. For purposes of the present disclosure, this system 10 shall generally be referred to as an ISN (investor social network). Various ISN 10 embodiments can have collaborative functionalities for investors, experts, venture capital, startup companies, and more, as further described herein. ISN 10 comprises a network 35 providing communication and communicative coupling between one or more ISN server(s) 90, one or more expert(s) 60, one or more expert computing device(s) 65, one or more investor(s) 70, one or more investor computing device(s) 75, one or more startup(s) 50, and one or more startup computing device(s) 55. Network 35 may comprise any one or more of e.g., internet, cellular, Bluetooth™, Wi-Fi, satellite, enterprise, private network, similar networks, or combinations of the foregoing. Investor computing devices 75 and startup computing devices 55 may comprise e.g., computers, databases, servers, mobile device, tablets, etc. as well as respective peripheral devices, such as cameras, microphones, memory, storage, etc. Any of investor computing devices 75, expert computing devices 65, startup computing devices 55, and/or ISN servers 90 can comprise one or more artificial intelligence or machine learning models or engines 15. AI/ML model(s) 15 can comprise different AI/ML models, different iterations of a single/similar AI/ML model, or comprise a single AI/ML model implemented and networked across multiple devices. For example, a “central” AI/ML model 15 could be running at any of investor computing devices 75, expert computing devices 65, startup computing devices 55, and/or ISN servers 90, and others of the foregoing devices could function like an output/input interface to the AI/ML model 15, allowing user input, data collection, user interface for a user, etc.

It should be understood that AI/ML model 15 can comprise one or more AI/ML model, engines, programs, algorithms, etc. Commonly the terms machine learning engine or machine learning algorithm are used to refer to a specific algorithm. The term artificial intelligence commonly is used to refer to an entire system that achieves intelligence-like outcomes while using multiple sub-systems, such as multiple machine learning algorithms. But both ML and AI have been used to identify a variety of functionalities or types of systems that utilize various combinations of specific ML algorithms. As used herein, AI/ML model is intended to denote a variety of AI/ML functionalities that fall under the category of ML algorithms and systems that utilize such functionalities. Examples of AI/ML engine 15 can comprise any one or more of: supervised learning, reinforcement learning, natural language processing such as large language models (LLMs), neural networks, computer vision, facial recognition, chatbots, virtual assistants, unsupervised learning, generative AI, other AI or ML models, and/or combinations of any of the foregoing.

One embodiment of ISN 10 is to allow social networking and investment opportunities reviews by experts 60 to startups 50 and investors 70. For example, a startup 50 may create a presentation, pitch, one-pager, or other materials using startup computing devices 55. Such materials can be stored at e.g., ISN servers 90 and may be accessed by experts 60 via expert computing devices 65. Various experts 60 can then review the materials and provide e.g., feedback, ratings, rankings, or other types of grading or feedback, which can then be viewed by e.g., other investors 70, startups 50, other third parties, and/or combinations of the foregoing.

Certain embodiments of ISN 10 include the ability to:
Match startups with qualified experts via vector based algorithms to enable scalable analysis;
Employ various transformer architectures to extract signals from noisy data based on multiple opinions; and
Continually enhance decision-making via feedback loops between the human and AI components.

ISN 10 can, rather than replace human evaluators, forge a collaborative framework augmenting human strengths with machine capabilities. The system aims to balance data-driven objectivity with nuanced and diverse subjective assessments. As such ISN 10 can enhance venture capital decisions-increasing accuracy, scalability, and speed by judiciously blending AI and collective human perspectives.

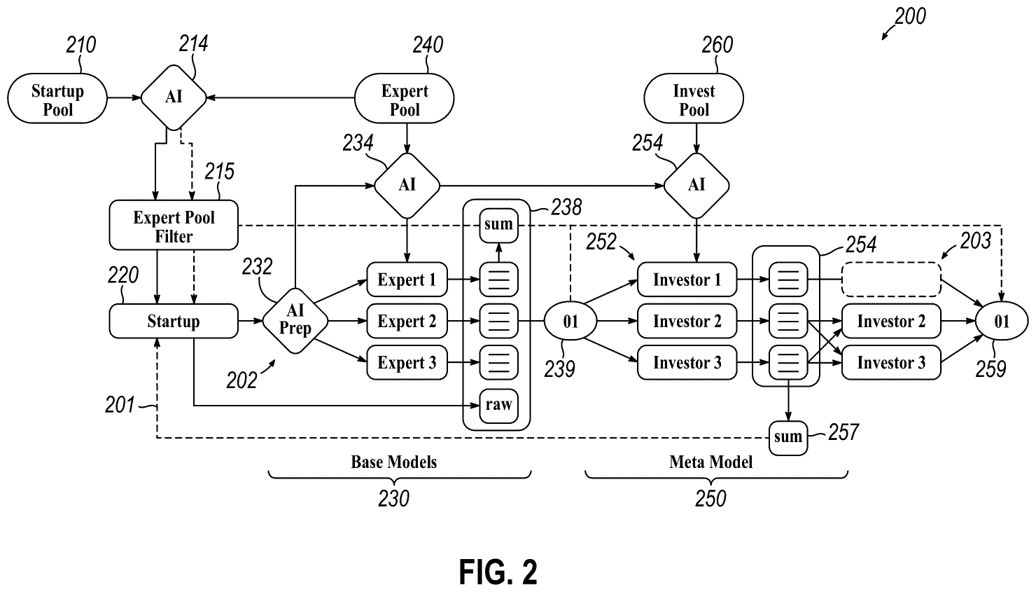

FIG. 2 illustrates a method 200 for certain embodiments of ISN 10 under the present disclosure. Method 200 is a process flow performed by ISN 10 and its components for selecting investment targets and aggregating expert and investor opinion and investment on the targets. Method 200 can begin with a startup pool 210. This may be obtained by receiving applications from companies desiring funding.

An initial stage, known as candidate generation via expert pool filter 215, is effectively tailored for the extensive and intricate process of selecting startups. Tools such as AI 214 can be used to assist in the expert pool filter 215 using auto video moderation, transcription, summarization, validation and classification using a variety of transformer architectures. This stage dramatically reduces the noisy initial dataset, potentially encompassing thousands of applicants, to a more manageable group of e.g., a few hundred at startup 220 for review by experts. Experts review process is designed similar to two-stage recommender systems. The initial reduction in the number of applicants is accomplished through the use of actions or algorithms that are not only straightforward but also light on computational resources. Such a strategy can be valuable given the voluminous nature of data in startup ecosystems, where the proportion of applications to funded startups is substantially high. This initial phase involves independent voting by domain experts (from expert pool 240) on startup candidates based on limited and summarized information on contenders that does not require a lot of time to review. At this stage, experts simply vote if the startup idea is good enough for thorough expert review. These votes are subsequently adjusted based on similarity algorithms and experts historical review records, ensuring a match between the startups and each expert's specific field of knowledge and ensuring alignment of expert rating scales. This process mirrors the “mixture of experts” model, where decision-making is entrusted to specialized models while ensuring the models use the same ranking ranges. Hence, embodiments can mitigate the biases inherent in the prior art by enforcing independent expert decisions and providing collective feedback only after an investment decision has been made. The importance of domain expertise is especially notable at the domain performance level. The research indicates that overall crowd performance within specific domains consistently outperforms individual efforts. This phenomenon, where the mean domain-level crowd percentile rank notably exceeds the individual question-level performance, validates the robust wisdom-of-crowds effect in aggregating domain-specific expertise. Moreover, variability in performance across domains correlates with the level of expertise differentiation, reinforcing the need for careful expert selection in areas with high differentiation.

The second stage involves an evaluation step 230 by an expert pool 240 (e.g., experts 60 of FIG. 1), focusing on areas such as team expertise, market opportunity, market traction, product or service, go-to-market strategy. There may be various expert pools 240 for various industries, e.g., telecommunications, medical technologies, etc. Each applicant who received a top percentile score during initial stage 220 from startup pool 210 may be assigned an appropriate expert pool 240 or group of expert pools 240 based on their industry. In this stage a more intricate and time-consuming algorithmic process is employed to re-rank the shortlisted candidates. In this phase, the carefully selected panel of experts of highly differentiated domains functions as a “wise crowd” and provide their analyses 238 (e.g., votes, detailed feedback, writeups, etc.). These analyses can be ensembled in various ways or embodiments such as e.g., in a manner akin to how random forest (RF) classifiers amalgamate predictions from multiple ‘weak learner’ models. Although other embodiments may use techniques besides RF. An AI prep step 232 can use AI/ML to create/provide basic information about each startup 220, such as e.g., industry background, founder information/biography, one pagers, economic analyses by geography or industry, or other useful information. AI 234 can also assist the expert pool 240 in creating their analyses 238.

An output of evaluation step 230 can be a consensus rating 239. Consensus rating can be any type of metric used to measure or predict the success of a startup 220. Examples of consensus rating 230 could be a predicted company valuation (e.g., $10 million USD), a value based on a rating scale (e.g., 7 out of a possible 10), or another metric, weighting, or value used to rank or rate startups 220.

After evaluation step 230, an investment evaluation step 250 can proceed. An investor pool 260 (e.g., investors 70 of FIG. 1) can provide feedback on each top-rated startup 220, using the consensus rating 239 and/or other inputs, such as information provided by AI 254, such as industry background, founder information/biography, one pagers, economic analyses by geography or industry, or other useful information. There may be various investor pools 260 for various industries, e.g., telecommunications, medical technologies, etc. Each potential startup 220 from startup pool 210 may be assigned an appropriate investor pool 260 or group of expert pools 260 based on their industry. Investment evaluation step 250 preferably comprises multiple analysis layers 252, 254, such as layers in a ML model, with potential for feedback or feedforward functionality for enhanced evaluation techniques. An output can comprise an investment rating 259 for each startup 220. Preliminary outputs 257 of different analysis layers 252, 254, can be fed back to earlier steps for startup 220. Investment rating 259 also can be fed back to earlier steps in the process.

Embodiments of ISN 10 and method 200 can integrate, at least, the following aspects.
Wisdom of the Crowd: Embodiments can leverage the ‘wisdom of the crowd’ by incorporating insights from a diverse panel of domain experts. This can mitigate the effects of social influence on crowd performance by ensuring independent expert decisions. It can also aggregate domain-specific expertise to enhance overall decision-making accuracy.
AI-Driven Analytics: For a given domain such as “AI/ML” a stratified random sample can be taken from the pools of experts: technologists, founders, and investors with experience/expertise in the domain thus making sure that every expert panel has the experts in the same proportions to make the scores compatible. LLM (large language models) can be employed for deep analysis and synthesis of complex insights from expert reviews and review discussions assembling case study library for future reference. This can also help ensure a diverse and highly qualified panel for analysis and facilitates actionable insights to improve performance over time.
Expert Collaboration: Embodiments can assemble a panel of domain experts with technical expertise, founding or investing experience in the field. Embodiments can then allow these experts to conduct independent evaluations, selecting prospective startups for detailed review and providing in-depth analyses.
Expert Motivation: Embodiments can allow for equity to be given to experts who provide their insight. For example, 0.5% of equity in all funded startups could be captured by the experts (individually or by a fund representing the experts collectively). In some embodiments, experts can receive an equity stake (in the funded startup or the collective fund) for every detailed review, which aligns their financial outcomes with the outcome of the manager of e.g., ISN 10, any expert equity fund, and start-up investors, because the received equity stake value directly depends on applicants' future performance. In some embodiments, experts are motivated to create high-quality detailed reviews as after an investment decision is made, the entire expert community can see, discuss, and evaluate their feedback. While highly insightful reviews may receive positive feedback from the community, sloppy or nonsensical reviews may be downvoted which may result in expert disqualification.
Expert Feed Back Loop: In certain embodiments, to improve experts' performance over time, they can see all finished cases, upvote, comment, and discuss reviews of other experts. Such embodiments can help prevent bad actors from abusing the process or prevent nonsensical reviews as these will be spotted by the community and the expert can be banned from further activity. Newly joined experts can tap into the existing case study pool while existing experts can receive actionable feedback on their reviews. In certain embodiments experts may be anonymous. In some embodiments, while experts may remain anonymized on the platform, their avatars or nicknames may earn a reputation or karma within the expert community over time from providing insightful reviews or discussion points.
Investor Integration: In some embodiments, reviews of top-rated startups can be presented to investors actively investing in the domain. Investors can review compiled expert opinions and add a financial and market feasibility assessment thus providing investments to deals that are or are not a good fit for an investment. These embodiments may ensure that investment decisions are technically robust, financially sound, and market ready.

FIGS. 1 and 2 and the above description help to illustrate several general embodiments. Below further detail is given on certain possible embodiments and further detail on different aspects of possible embodiments of ISN 10 and method 200.

### Candidate Generation

The narrowing of the startup pool 210 to selected startups 220 (candidate generation 215 of FIG. 2) can involve various tools or methods for narrowing and selecting candidates. These can include moderation and validation. For example, in some embodiments each possible startup in the startup pool 210 can upload materials (e.g., documents, videos, data, financial projections, etc.) about themselves. This can be done, e.g., via startup computing devices 55 of FIG. 1 for storage at ISN servers 90 and use by experts 60 via expert computing devices 65 and use by investors 70 via investor computing devices 75. In one example, the startup uploads a 2-minute video to the platform using a mobile application. The video could be saved in the cloud at ISN servers 90 for later use (e.g., in AWS S3 or other cloud platforms). ISN 10 may implement a moderation step on the video. For example, the video can be processed by auto-moderation programs or APIs which flag inappropriate or harmful content whether verbal, image-based, or sound-based. Or ISN 10 could deploy a second-stage custom validation model, which could flag anything that is not classified as human talking, to ensure startups are uploading human presentations, for example. Next, ISN 10 can implement a validation step, e.g., ISN 10 could use a transcription API to transcribe the video into a text file.

ISN 10 could then inject the transcription into a prompt that is then sent to an LLM API (e.g., AWS Bedrock) that acts as a zero-shot classifier to determine if the pitch is matching one or more expert pools available to ISN 10, such as AI/ML, MedTech, Hardware etc. Certain embodiments can comprise further validation. For example, additional validation can make sure that the transcript is longer than a minimum required length. If the submission does not match any of the existing pools, ISN 10 can use the LLM to still classify it and store it for future reference, at e.g., ISN servers 90. ISN 10 could in some embodiments send the startup an automated message saying that applications are not being considered in this domain at this time.

Candidate generation 215 of FIG. 2 can involve voting by experts 60 in some embodiments. For example, if the video matches one of the expert pools 240, the video, and its summary are distributed among all experts 60 from the matching expert pool 240 for initial voting (e.g., scoring one to five) on whether a startup should undergo further review. For example, AI/ML experts will not be asked to grade pure MedTech startups. The engagement of experts 60 and expert pool 240 can be by e.g., push notification from ISN servers 90 to expert computing devices 65 (such as a notification to watch a video submission). Experts' votes can be weighted based on the historical rankings by the individual experts 60, to make sure experts' review scales are aligned. For example, while one expert can be operating within 3 to 5 star range another could utilize the whole 1 to 5 scale. These scales are preferably normalized to prevent random selection of top startups due to pure luck of a high number of “high-graders” in an expert panel. Startups with scores in a top percentile (e.g., top 1% or 5%) are selected for a detailed expert review (e.g., evaluation step 230 of FIG. 2).

In some embodiments, selected startups can be asked to upload an additional number of videos (e.g., five videos up to 2-minutes long addressing specific areas of their business) and upload any additional relevant documents for experts' review. The same moderation and validation process could be applied to newly uploaded videos. In some embodiments, if a number of low scores makes it highly unlikely that a startup application may still reach the top percentile score, such applications could be removed from the evaluation process.

### Expert Evaluations

Certain embodiments can comprise an expert selection step for selecting/inviting/creating e.g. expert pool 240 of FIG. 2. In some variations an initial group of experts is hand-selected and invited to the platform, based on their career track record, research publications, or other metrics or parameters. Some variations can later continue by invite-only, and invited persons will be reviewed by the community before they are accepted as experts.

Evaluation step 230 of FIG. 2 can comprise a variety of tools and techniques for data analysis and expert opinion formation. Preferably, a diverse panel of at least 20 experts is sampled from a given expert pool (e.g., AI/ML, commercial products, telecommunications). Preferably a panel could comprise 50% technical experts, 25% founder-experts, and 25% investor experts. Random sampling can be used to make sure that every panel has a unique composition and that experts have an equal chance of being selected to work on a panel. In some embodiments, experts who have made more reviews are less likely to get another invitation, while experts who have not made any reviews are more likely to get one, to make sure everyone has an opportunity to participate and improve user experience.

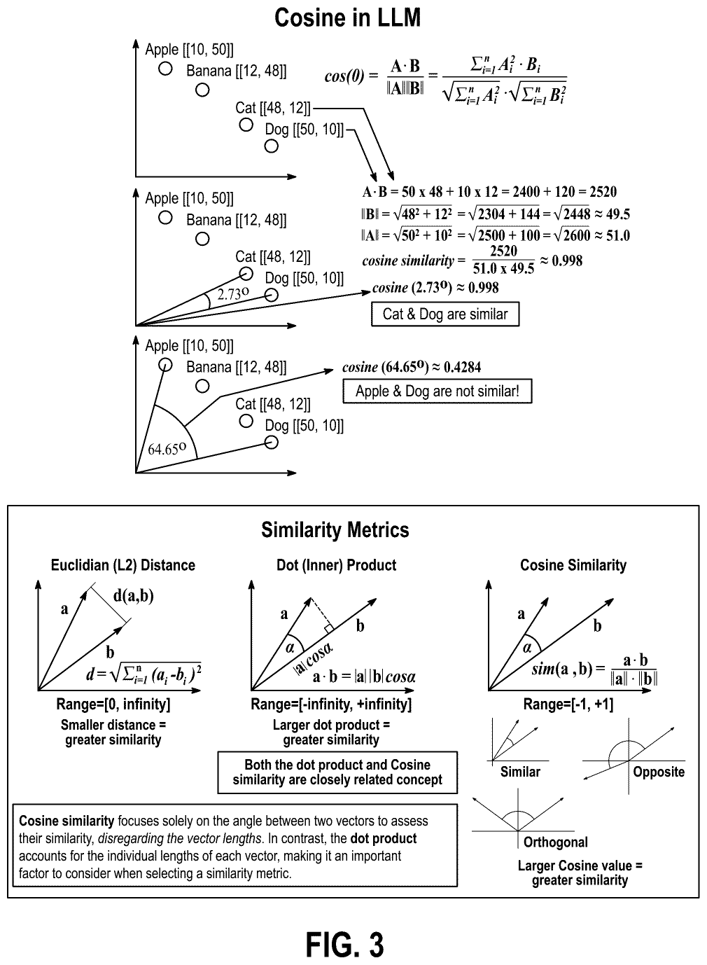

It is desired that experts 60 have expertise in domains relevant to the given startup 50. In certain embodiments, AI can match experts 60 and startups 50 based on similarity metrics e.g., cosine similarity, Euclidian distance, or Dot (inner) product. For example, AI could review a text biography of each potential expert, and a text write up of each startup 50, convert the text into vectors and match experts 60 with startups 50 based on cosine similarity. Similarity metrics refers to various techniques of comparing distance/proximity in a vector space. An overview of similarity metrics is shown in FIG. 3. Other similarity metrics can be used in various embodiments.

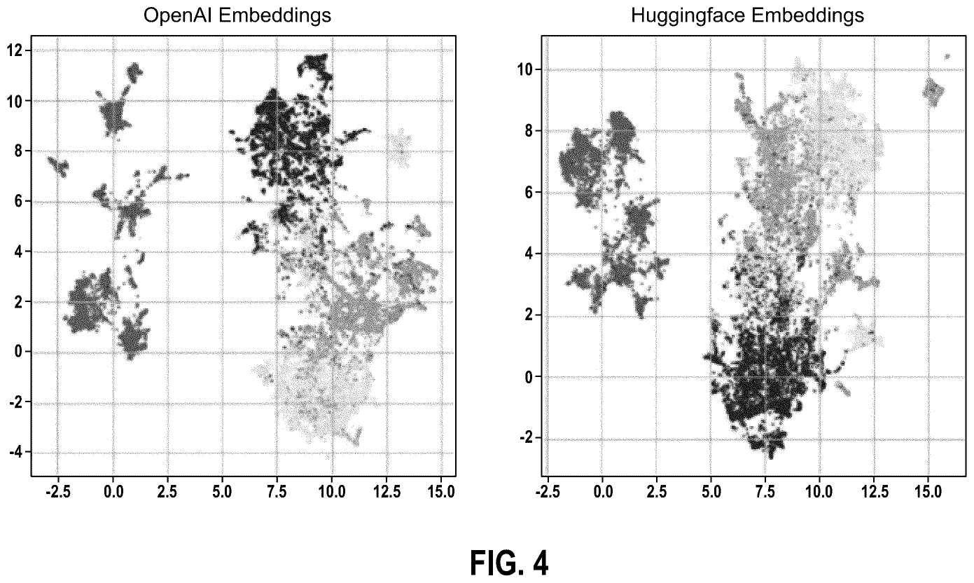

Other ways of calculating similarity (or fit between experts 60 and startups 50) can be by using embedding models. For example, AWS Sagemaker can be used for real-time inference calculations. Different embedding models may yield different embeddings for the same texts, so it may be desired to standardize an embedding model across different analyses with e.g. ISN 10. Or it may be desired to use multiple embedding models to compare results, in some embodiments. FIG. 4 shows how different embedding models may yield different embedding results from the same text.

During evaluation step 230, detailed and relevant data can be distributed among selected experts for independent and anonymous analysis. Preferably, experts do not see each other's reviews until an investment decision is made which mitigates groupthink biases. In some embodiments experts can be required to write a paragraph-long review highlighting the most important aspects of the application based on their expertise. Other submission types or lengths by experts could be used.

Synthesis of expert opinions to create a consensus rating 239 of FIG. 2 can take a variety of forms in various embodiments. In some embodiments, AI (e.g., LLM API such as Bedrock+prompt) can integrate individual analyses 238 into a unified report, highlighting key insights, risks, and opportunities. It can also create a report summarizing feedback from every expert group: technical, founders, and investors to make sure no single group has an extremely negative review.

In some embodiments, method 200 of FIG. 2 can stop at the consensus rating 239 if the expert pool reaches a consensus. A user of ISN 10 could make an investment based on only the consensus rating 239 if it is clear. But in some embodiments, further input may be desired from investors.

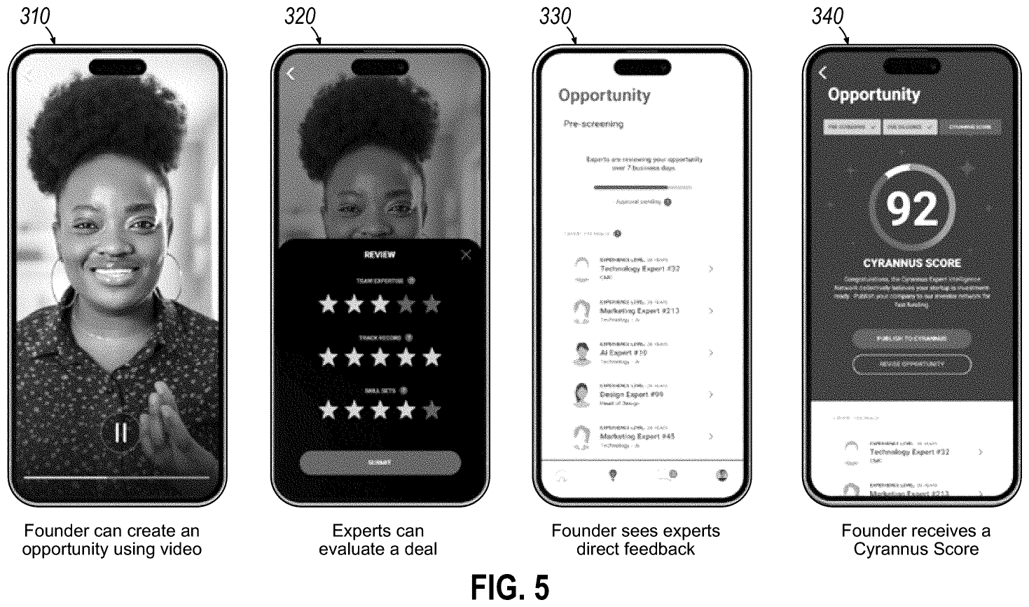

FIG. 5 illustrates possible user interfaces used during method 200 of FIG. 2, such as for the candidate generation 215 and evaluation 230 steps. User interfaces 310-340 may be shown to e.g., startups 50 and experts 60 via startup and expert computing devices 55, 65. For example, video user interface 310 can be shown to startup 50 and can be used to create an introductory video, audio, or other materials. Once the video is seen by expert pool 240, each expert may see rating user interface 320, which allows each expert 60 to rate the startup. Rating can be out of five stars, out of 100 points, or various other types of measuring feedback, including freeform text entry. Feedback interface 330 can be provided to startups 50 with the feedback from the experts 60. Consensus rating interface 340 can be provided to startups 50, experts 60, and investors 70 and can show consensus rating 239 of FIG. 2, and/or other information about the startup 50.

### Investor Evaluation

Investor evaluation step 250 of FIG. 2 can comprise a variety of tools and techniques for investor deliberation and decision-making. A user/manager of ISN 10 may make investment decisions based only on the previous expert evaluation, or may proceed to use investor input and present a startup's information to potential investors 70 of an investor pool 260.

Information provided to investor pool 260 can comprise e.g., one pagers, summarized case studies of similar startups, anonymized experts' feedback, raw data from the startups, expert consensus rating 239, expert analyses 238, and/or other information. Investor pool 260 can comprise e.g., investors 70 of FIG. 1, accredited investors such as angel inventors, venture funds, family offices, mutual funds, etc. These entities can make offers on different terms than e.g., a manager of ISN 10, which enables them to syndicate larger or smaller rounds depending on the deal quality.

The creation of investment rating 259 can use various ML techniques. Certain embodiments can utilize decision flow similar to MLP (multilayer perceptron), where while perceptrons are allowed to interact during the process thus making the decision making non-independent, only a single perceptron needs to fire for a positive outcome the same as only as single investor may be required to make the investment. In certain embodiments, ISN 10 can assemble an investor jury (e.g., investor pool 260 or a subset thereof) using a matching algorithm, informed by semantic similarity metrics, to identify potential backers. At this stage only a single positive investment decision is required to go forward with the investment, therefore investors are allowed to interact with each other and have all available information available to make the decision. In this way MLPs can allow interaction between the decision nodes in the model structure and aid in capturing complex data patterns, thereby bolstering the predictive capacity of the system. Similarly to MLP, investors have all available information and create their feedback which is shared between all investors before they make individual independent investment final decision.

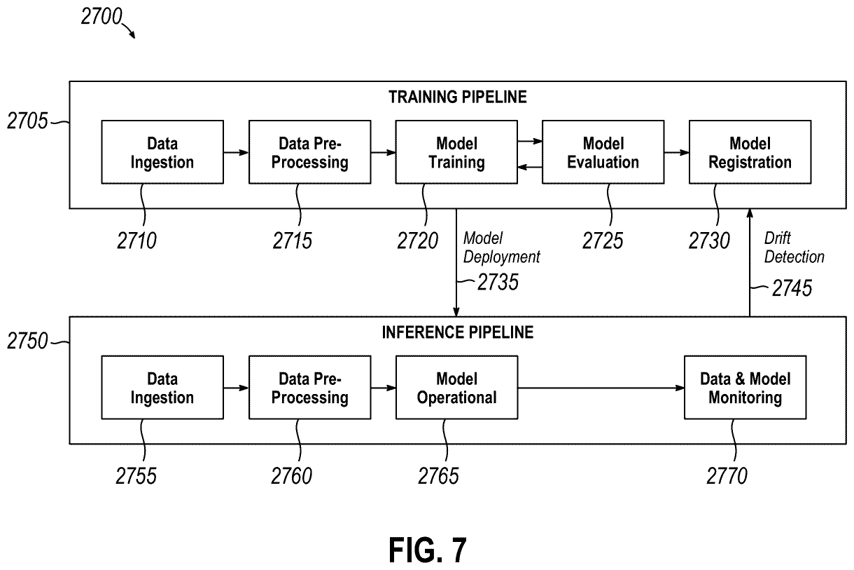

FIG. 7 shows possible user interfaces for use during method 200 of FIG. 2, and during investment evaluation 250 or other steps of method 200. User interfaces 510-540 may be shown to e.g., experts 60 and investors 70 via expert and investor computing devices 65, 75. Startup score user interface 510, for example, may be provided to investors 70 to review information about a startup 50. Credits interface 520 may be provided to experts as they earn credits for their input during evaluation step 230. Investment interface 530 can be provided to experts 60 or investors 70 to show their investments in startups 50 that they choose to invest in. Newsroom interface 540 can show links to news stories or other information about startups 50 or other participants in ISN 10.

### Expert Feedback and Review

After an investment decision is made whether positive or negative, resulting in investment rating 259, AI tools can be used to succinctly summarize and communicate feedback to the expert panel, expert community and the applicant. For example, in some embodiments feedback and feedforward loops 201, 202, 203 in FIG. 2 can be used. These loops illustrate how data from various stages of method 200 can be used as feedback or feedforward in ML models.

For example, in some embodiments experts can see anonymized individual reviews and may continue the discussion about the case. While discussion might not change the outcome of the case, it may improve collective knowledge and thus future performance and provide fine-grained reasoning of experts that cannot be captured within one-paragraph reviews. The discussion is still preferably anonymized to prevent spillover effects of real-world reputation. This may be crucial as it is likely best to capture true knowledge so experts engaged in discussion must not be intimidated by the real-world reputation of their opponents. They should also be free to express unpopular opinions which might go against the status quo. Information from the discussion can also be added to a case study in a case study library. These feedback loops 201, 202, 203 can help to continuously refine the analysis and decision-making processes within ISN 10 and method 200 and other embodiments.

### Case Library & Knowledge Base

In some embodiments, ISN servers 90 of FIG. 1 can comprise a case study library or database. In some embodiments case study library comprises a vector-based knowledge database suitable for knowledge retrieval and retrieval-augmented generation. This case library can be used as the training set to train a domain specific model to pre-qualify startup applications as additional step to reduce number of applicants 210 to make sure the expert pool 240 only sees high-grade applications for initial screening. Disqualified applications can in some cases receive detailed and actionable LLM-generated feedback based on the retrieved historical reviews and discussions from case library knowledge base. Additionally, in some variations ISN 10 can allow expert pool 240 or investor pool 260 to refer to the case library to assist in and ramp up decision-making.

### ADDITIONAL EMBODIMENTS

As described above, certain embodiments of the present disclosure can comprise the use of AI/ML to analyze investment opportunities, expert advice, investor decisions, and related metrics and variables. As shown in FIG. 1, ISN 10 may comprise or use one or more AI/ML model(s) 15, but AI/ML model 15 can be performed, implemented, or stored at any of expert computing devices 65, investor computing devices 75, startup computing devices, ISN servers 90, or combinations of the foregoing. Data used to train or implement any of AI/ML models 15 may be stored at any of the components described with respect to FIG. 1.

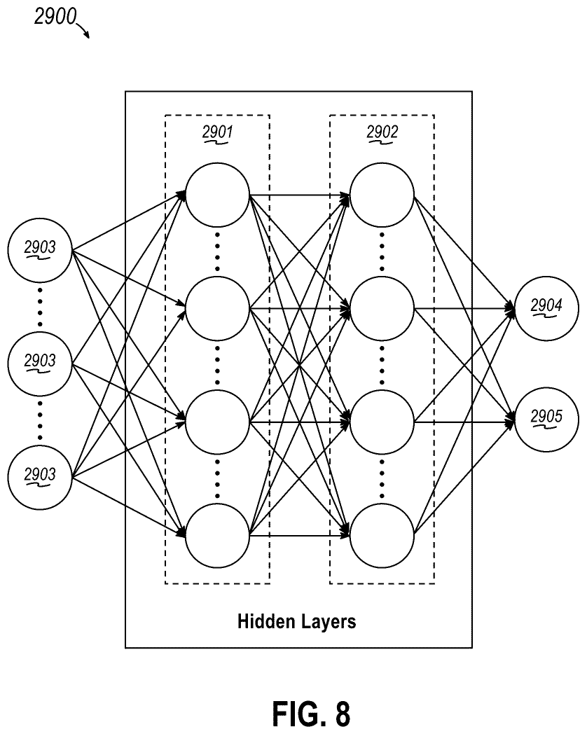

The architecture of an AI/ML model 15 (e.g., structure, number of layers, nodes per layer, activation function etc.) may need to be tailored for each particular use case. Building an AI/ML model 15 can include several development steps where the actual training of a ML model or algorithm is just one step in a training pipeline. One aspect in AI/ML development is AI/ML model lifecycle management. One embodiment of a model lifecycle management procedure 2700 is illustrated in FIG. 8. The model lifecycle management can in some embodiments comprise two pipelines: a training pipeline 2705 and an inference pipeline 2750.

At 2710 in the training pipeline 2705, data ingestion 2710 occurs, which includes gathering raw (training) data from a data storage. After data ingestion 2710, there may also be a step that controls the validity of the gathered data. At 2715 data pre-processing occurs, which can include feature engineering applied to the gathered data. This may involve, e.g., data normalization or data formatting or transformation required for the input data to the AI/ML model. After the ML model's architecture is fixed, it should be trained on one or more datasets. At 2720 model training is performed in which the AI/ML model is trained with the raw training data. To achieve good performance during live operation in a system (the so-called inference phase), the training datasets should be representative of actual data the ML model will encounter during live operation. The training process often involves numerically tuning the ML model's trainable parameters (e.g., the weights and biases of the underlying neural network (NN)) to minimize a loss function on the training datasets. The loss function may be, for example, based on a maximizing student learning (possibly against a standardized test or other measure); minimizing disruptive behavior; minimizing teacher hours spent on lesson plans, or other metrics. The purpose of the loss function is to meaningfully quantify the reconstruction error for the particular use case at hand. At 2725 model evaluation can be performed where the performance is benchmarked to some baseline. Model training 2720 and evaluation 2725 can be iterated until an acceptable level of performance is achieved. At 2730 model registration occurs, in which the AI/ML model is registered with any corresponding data on how the AI/ML model was developed, and e.g., AI/ML model evaluation data. At 2735 model deployment occurs, wherein the trained/re-trained AI/ML model is implemented in the inference pipeline 2750.

Data ingestion 2755 in the inference pipeline 2750 refers to gathering raw (inference) data from a data source. Data pre-processing 2760 can be essentially identical/similar to the data pre-processing 2715 of the training pipeline 2705. At 2765, the operational model received from the training pipeline 2705 is used to process new data received during operation of e.g., ISN 10 of FIG. 1 or components thereof. At 2770 data and model monitoring is performed. Here the inference data is analyzed to determine whether the inference data are from a distribution that aligns with the training data, as well as monitoring model outputs for detecting any performance, or operational, variance or drifts. The variance or drift is used at 2745 (drift detection) to update the AI/ML model registration.

The training process is typically based on some variant of a gradient descent algorithm, which, at its core, typically comprises three components: a feedforward step, a back propagation step, and a parameter optimization step. These steps can be described using a dense ML model (i.e., a dense NN with a bottleneck layer) as an example.

Feedforward: A batch of training data, such as a mini-batch, (e.g., several downlink-channel estimates) is pushed through the ML model, from the input to the output. The loss function is used to compute the reconstruction loss for all training samples in the batch. The reconstruction loss may be an average reconstruction loss for all training samples in the batch.

Back propagation (BP): The gradients (partial derivatives of the loss function, L, with respect to each trainable parameter in the ML model) are computed. The back propagation algorithm sequentially works backwards from the ML model output, layer-by-layer, back through the ML model to the input. The back propagation algorithm is built around the chain rule for differentiation: When computing the gradients for layer n in the ML model, it uses the gradients for layer n+1.

Parameter optimization: The gradients computed in the back propagation step are used to update the ML model's trainable parameters. An approach is to use the gradient descent method with a learning rate hyperparameter (a) that scales the gradients of the weights and biases. It is preferred to make small adjustments to each parameter with the aim of reducing the average loss over the (mini) batch. It is common to use special optimizers to update the ML model's trainable parameters using gradient information. The following optimizers are widely used to reduce training time and improving overall performance: adaptive sub-gradient methods (AdaGrad), RMSProp, and adaptive moment estimation (ADAM).

The above process (feedforward, back propagation, parameter optimization) can be repeated many times until an acceptable level of performance is achieved on the training dataset. An acceptable level of performance may refer to the ML model achieving a pre-defined average reconstruction error over the training dataset (e.g., normalized MSE of the reconstruction error over the training dataset is less than, say, 0.1). Alternatively, it may refer to the ML model achieving a pre-defined value chosen by a user.

In some implementations, a function F(⋅) may be generated by a ML process, such as, for example, supervised learning, reinforcement learning, and/or unsupervised learning. It should further be understood that supervised learning may be done in various ways, such as, for example, using random forests, support vector machines, neural networks, and the like. By way of non-limiting example, any of the following types of neural networks that may be utilized, including, deep neural networks (DNNs), convolutional neural networks (CNNs), and recurrent neural networks (RNNs), or any other known or future neural network that satisfies the needs of the system. In an implementation using supervised learning the neural networks may be easily integrated into the hardware described in ISN 10 of FIG. 1 (e.g., in the form of simple vector-matrix multiplications).

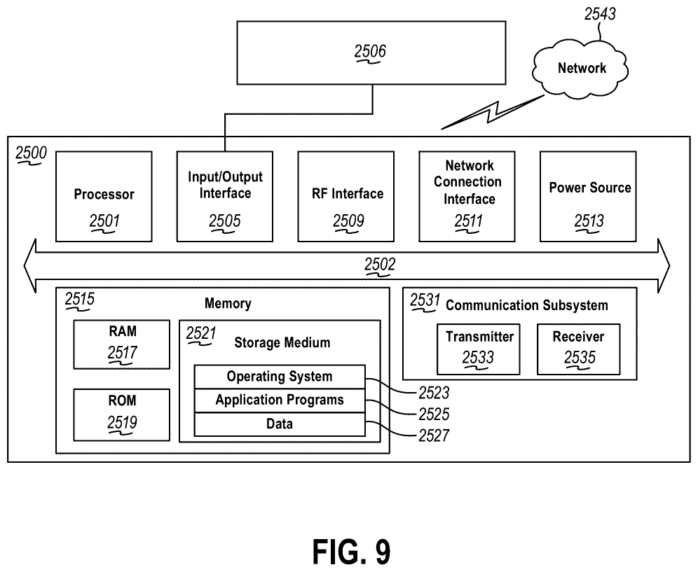

Referring now to FIG. 9, an example NN 2900 (e.g., DNN) is shown. In some implementations, and as shown, the neural network 2900 may include multiple hidden layers represented by dashed boxes 2901 and 2902. In one implementation, the inputs 2903 may be fed into the NN 2900. Next, the inputs 2403 may go through a set of hidden layers (e.g., 2901 and/or 2902). Once the inputs 2903 pass though the hidden layers 2901 and/or 2902, they may yield outputs 2904, 2905 (e.g., as an output layer). Outputs 2904, 2905 can comprise any metric or data that e.g., ISN 10 seeks to optimize, for example, expert accuracy, return on investment, or another output valuable. Possible inputs can include e.g.: industry type, founder identification, founder background, expert identification and that expert's ratings, investor identification and success, or other variables.

As should be understood by one of ordinary skill in the art, in order for the NN 2900 to output proper a proper analysis, it should be trained properly (e.g., with a collection of samples) to accurately extract the likelihood values. If not trained properly, overfitting (e.g., when the NN memorizes the structure of the preambles but is unable to generalize to unseen preamble characteristics) or underfitting (e.g., when the NN is unable to learn a proper function even on the data that it was trained on) may happen. Thus, implementations may exist that prevent overfitting or underfitting, involving a set of well-engineered features that must be extracted from the preamble characteristics.

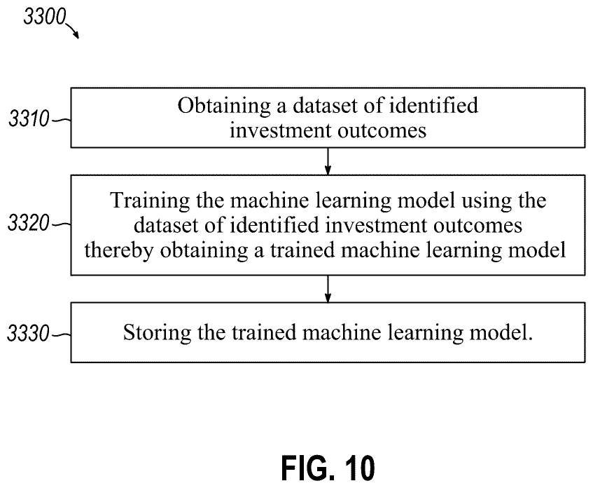

FIG. 10 illustrates an embodiment of various computing devices within ISN 10 of FIG. 1, or components thereof e.g., ISN servers 90, expert computing devices 65, startup computing devices 55, investor computing devices 75, or other computing or smart devices described herein. FIG. 10 shows a schematic block diagram of a computing device 2500 (or components thereof) according to certain embodiments of the present disclosure. System 2500 can be used to analyze and/or optimize: the functionalities described with respect to ISN 10 or other computing or smart devices described herein, or to perform other methods or ML-related tasks and analyses as described herein.

Computing device 2500 includes processor 2501 that is operatively coupled via a bus 2502 to an input/output interface 2505, a power source 2513, a memory 2515, a RF interface 2509, network communication interface 2511, and/or any other component, or any combination thereof. The level of integration between the components may vary from one embodiment to another. Further, certain computing devices 2500 (or components thereof) may contain multiple instances of a component, such as multiple processors, memories, transceivers, transmitters, receivers, etc.

The processor 2501 is configured to process instructions and data and may be configured to implement any sequential state machine operative to execute instructions stored as machine-readable computer programs in memory 2515. Processor 2501 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processor 2501 may include multiple central processing units (CPUs).

In the example, input/output interface 2505 may be configured to provide an interface or interfaces to an input/output device(s) 2506, such as a screen, keyboard, indicator light, keypad, touchscreen, or other input or output device. Other examples of an output device include a speaker, a sound card, a video card, a display, a monitor, a printer, an actuator, an emitter, a smartcard, another output device, or any combination thereof. An input device may allow a user to capture information into system 2500. Other examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 2513 is structured as a battery or battery pack. Other types of power sources, such as an external power source (e.g., an electricity outlet), photovoltaic device, or power cell, may be used. The power source 2513 may further include power circuitry for delivering power from the power source 2513 itself, and/or an external power source, to the various parts of computing device 2500 via input circuitry or an interface such as an electrical power cable.

Memory 2515 may be configured to include memory such as random-access memory (RAM) 2517, read-only memory (ROM) 2519, programmable read-only memory (PROM), erasable programmable read-only memory (EPROM), electrically erasable programmable read-only memory (EEPROM), magnetic disks, optical disks, hard disks, removable cartridges, flash drives, other storage medium 2521, and so forth. In one example, the memory 2515 includes one or more application programs 2525, an operating system 2523, web browser application, a widget, gadget engine, or other application, and corresponding data 2527. Memory 2515 may store, for use by the computing device 2500, any of a variety of various operating systems or combinations of operating systems. An article of manufacture, such as one including a simulation system or communication system may be tangibly embodied as or in memory 2515, which may be or comprise a device-readable storage medium.

Processor 2501 may be configured to communicate with an access network or other network using the RF interface 2509 or network connection interface 2511. The RF interface 2509 or network connection interface 2511 may comprise one or more communication subsystems and may include or be communicatively coupled to an antenna. In the illustrated embodiment, communication functions of the RF interface 2509 or network connection interface 2511 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof.

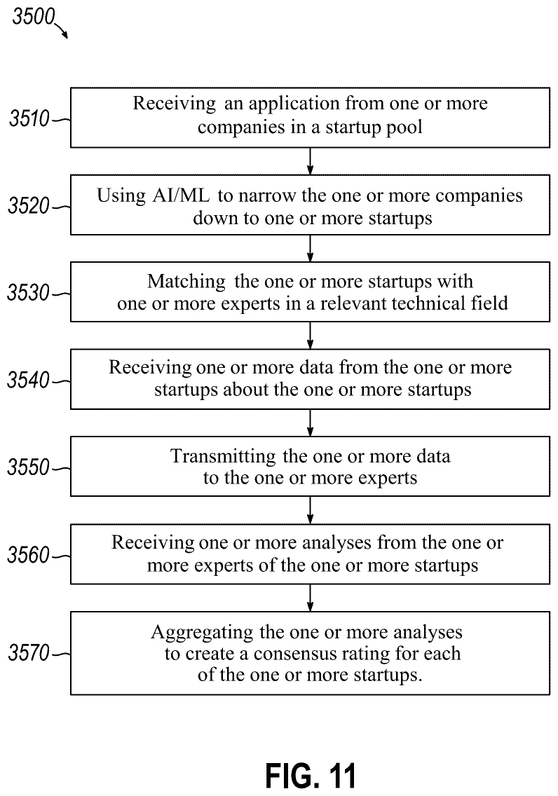

A possible method embodiment under the present disclosure is shown in FIG. 11. Method 3300 comprises a computer implemented method for training a machine learning model for optimizing investment outcomes. Step 3310 is obtaining a dataset of identified investment outcomes. Step 3320 is training the machine learning model using the dataset of identified investment outcomes thereby obtaining a trained machine learning model. Step 3330 is storing the trained machine learning model. Method 3300 can comprise a variety of additional or alternative steps. For example, further variations could include training a machine learning model for optimizing identified investment outcomes, wherein the training comprises; training the machine learning model using a dataset of one or more identified investment outcomes, thereby obtaining a further trained machine learning model; and storing the further trained machine learning model.

Another possible method embodiment under the present disclosure is shown in FIG. 12. Method 3500 is a method for facilitating knowledge sharing between one or more startups, one or more experts, and one or more investors, and optimizing investment decisions. Step 3510 is receiving an application from one or more companies in a startup pool. Step 3520 is using AI to narrow the one or more companies down to one or more startups. Step 3530 is matching the one or more startups with one or more experts in a relevant technical field. Step 3540 is receiving one or more data from the one or more startups about the one or more startups. Step 3550 is transmitting the one or more data to the one or more experts. Step 3560 is receiving one or more analyses from the one or more experts of the one or more startups. Step 3570 is aggregating the one or more analyses to create a consensus rating for each of the one or more startups. Method 3500 can comprise a variety of additional steps or variations. For example, further steps could include training a AI/ML model using the one or more data, one or more analyses, and/or one or more evaluations and related investment outcomes.

### Computing Device Embodiments

Although the computing devices described herein (e.g., ISN 10 of FIG. 1, servers, computing devices, etc.) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

It will be appreciated that computer systems are increasingly taking on a wide variety of forms. In this description and in the claims, the terms “controller,” “computer system,” or “computing system” are defined broadly as including any device or system—or combination thereof—that includes at least one physical and tangible processor and a physical and tangible memory capable of having thereon computer-executable instructions that may be executed by a processor. By way of example, not limitation, the term “computer system” or “computing system,” as used herein is intended to include personal computers, desktop computers, laptop computers, tablets, hand-held devices (e.g., mobile telephones, PDAs, pagers), microprocessor-based or programmable consumer electronics, minicomputers, mainframe computers, multi-processor systems, network PCs, distributed computing systems, datacenters, message processors, routers, switches, and even devices that conventionally have not been considered a computing system, such as wearables (e.g., glasses).

The computing system also has thereon multiple structures often referred to as an “executable component.” For instance, the memory of a computing system can include an executable component. The term “executable component” is the name for a structure that is well understood to one of ordinary skill in the art in the field of computing as being a structure that can be software, hardware, or a combination thereof. For instance, when implemented in software, one of ordinary skill in the art would understand that the structure of an executable component may include software objects, routines, methods, and so forth, that may be executed by one or more processors on the computing system, whether such an executable component exists in the heap of a computing system, or whether the executable component exists on computer-readable storage media. The structure of the executable component exists on a computer-readable medium in such a form that it is operable, when executed by one or more processors of the computing system, to cause the computing system to perform one or more functions, such as the functions and methods described herein. Such a structure may be computer-readable directly by a processor—as is the case if the executable component were binary. Alternatively, the structure may be structured to be interpretable and/or compiled-whether in a single stage or in multiple stages-so as to generate such binary that is directly interpretable by a processor.

The terms “component,” “service,” “engine,” “module,” “control,” “generator,” or the like may also be used in this description. As used in this description and in this case, these terms—whether expressed with or without a modifying clause—are also intended to be synonymous with the term “executable component” and thus also have a structure that is well understood by those of ordinary skill in the art of computing.

In terms of computer implementation, a computer is generally understood to comprise one or more processors or one or more controllers, and the terms computer, processor, and controller may be employed interchangeably. When provided by a computer, processor, or controller, the functions may be provided by a single dedicated computer or processor or controller, by a single shared computer or processor or controller, or by a plurality of individual computers or processors or controllers, some of which may be shared or distributed. Moreover, the term “processor” or “controller” also refers to other hardware capable of performing such functions and/or executing software, such as the example hardware recited above.

In general, the various exemplary embodiments may be implemented in hardware or special purpose chips, circuits, software, logic, or any combination thereof. For example, some aspects may be implemented in hardware, while other aspects may be implemented in firmware or software which may be executed by a controller, microprocessor, or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques, or methods described herein may be implemented in, as non-limiting examples, hardware, software, firmware, special purpose circuits or logic, general purpose hardware or controller or other computing devices, or some combination thereof.

While not all computing systems require a user interface, in some embodiments a computing system includes a user interface for use in communicating information from/to a user. The user interface may include output mechanisms as well as input mechanisms. The principles described herein are not limited to the precise output mechanisms or input mechanisms as such will depend on the nature of the device. However, output mechanisms might include, for instance, speakers, displays, tactile output, projections, holograms, and so forth. Examples of input mechanisms might include, for instance, microphones, touchscreens, projections, holograms, cameras, keyboards, stylus, mouse, or other pointer input, sensors of any type, and so forth.

### Abbreviations and Defined Terms

To assist in understanding the scope and content of this written description and the appended claims, a select few terms are defined directly below. Unless defined otherwise, all technical and scientific terms used herein have the same meaning as commonly understood by one of ordinary skill in the art to which the present disclosure pertains.

The terms “approximately,” “about,” and “substantially,” as used herein, represent an amount or condition close to the specific stated amount or condition that still performs a desired function or achieves a desired result. For example, the terms “approximately,” “about,” and “substantially” may refer to an amount or condition that deviates by less than 10%, or by less than 5%, or by less than 1%, or by less than 0.1%, or by less than 0.01% from a specifically stated amount or condition.

Various aspects of the present disclosure, including devices, systems, and methods may be illustrated with reference to one or more embodiments or implementations, which are exemplary in nature. As used herein, the term “exemplary” means “serving as an example, instance, or illustration,” and should not necessarily be construed as preferred or advantageous over other embodiments disclosed herein. In addition, reference to an “implementation” of the present disclosure or embodiments includes a specific reference to one or more embodiments thereof, and vice versa, and is intended to provide illustrative examples without limiting the scope of the present disclosure, which is indicated by the appended claims rather than by the present description.

As used in the specification, a word appearing in the singular encompasses its plural counterpart, and a word appearing in the plural encompasses its singular counterpart, unless implicitly or explicitly understood or stated otherwise. Thus, it will be noted that, as used in this specification and the appended claims, the singular forms “a,” “an” and “the” include plural referents unless the context clearly dictates otherwise. For example, reference to a singular referent (e.g., “a widget”) includes one, two, or more referents unless implicitly or explicitly understood or stated otherwise. Similarly, reference to a plurality of referents should be interpreted as comprising a single referent and/or a plurality of referents unless the content and/or context clearly dictate otherwise. For example, reference to referents in the plural form (e.g., “widgets”) does not necessarily require a plurality of such referents. Instead, it will be appreciated that independent of the inferred number of referents, one or more referents are contemplated herein unless stated otherwise.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms.

It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### CONCLUSION

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-limiting and exemplary embodiments of this disclosure.

It is understood that for any given component or embodiment described herein, any of the possible candidates or alternatives listed for that component may generally be used individually or in combination with one another, unless implicitly or explicitly understood or stated otherwise. Additionally, it will be understood that any list of such candidates or alternatives is merely illustrative, not limiting, unless implicitly or explicitly understood or stated otherwise.

In addition, unless otherwise indicated, numbers expressing quantities, constituents, distances, or other measurements used in the specification and claims are to be understood as being modified by the term “about,” as that term is defined herein. Accordingly, unless indicated to the contrary, the numerical parameters set forth in the specification and attached claims are approximations that may vary depending upon the desired properties sought to be obtained by the subject matter presented herein. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the subject matter presented herein are approximations, the numerical values set forth in the specific examples are reported as precisely as possible. Any numerical values, however, inherently contain certain errors necessarily resulting from the standard deviation found in their respective testing measurements.

Any headings and subheadings used herein are for organizational purposes only and are not meant to be used to limit the scope of the description or the claims. The terms and expressions which have been employed herein are used as terms of description and not of limitation, and there is no intention in the use of such terms and expressions of excluding any equivalents of the features shown and described or portions thereof, but it is recognized that various modifications are possible within the scope of the present disclosure. Thus, it should be understood that although the present disclosure has been specifically disclosed in part by certain embodiments, and optional features, modification and variation of the concepts herein disclosed may be resorted to by those skilled in the art, and such modifications and variations are considered to be within the scope of this present description.

It will also be appreciated that systems, devices, products, kits, methods, and/or processes, according to certain embodiments of the present disclosure may include, incorporate, or otherwise comprise properties or features (e.g., components, members, elements, parts, and/or portions) described in other embodiments disclosed and/or described herein. Accordingly, the various features of certain embodiments can be compatible with, combined with, included in, and/or incorporated into other embodiments of the present disclosure. Thus, disclosure of certain features relative to a specific embodiment of the present disclosure should not be construed as limiting application or inclusion of said features to the specific embodiment. Rather, it will be appreciated that other embodiments can also include said features, members, elements, parts, and/or portions without necessarily departing from the scope of the present disclosure.

Moreover, unless a feature is described as requiring another feature in combination therewith, any feature herein may be combined with any other feature of a same or different embodiment disclosed herein. Furthermore, various well-known aspects of illustrative systems, methods, apparatus, and the like are not described herein in particular detail in order to avoid obscuring aspects of the example embodiments. Such aspects are, however, also contemplated herein.

It will be apparent to one of ordinary skill in the art that methods, devices, device elements, materials, procedures, and techniques other than those specifically described herein can be applied to the practice of the described embodiments as broadly disclosed herein without resort to undue experimentation. All art-known functional equivalents of methods, devices, device elements, materials, procedures, and techniques specifically described herein are intended to be encompassed by this present disclosure.

When a group of materials, compositions, components, or compounds is disclosed herein, it is understood that all individual members of those groups and all subgroups thereof are disclosed separately. When a Markush group or other grouping is used herein, all individual members of the group and all combinations and sub-combinations possible of the group are intended to be individually included in the disclosure.

The above-described embodiments are examples only. Alterations, modifications, and variations may be affected to the particular embodiments by those of skill in the art without departing from the scope of the description, which is defined solely by the appended claims.

What is claimed is:

1. A computer implemented method for facilitating knowledge sharing between one or more startups, one or more experts, and one or more investors, and optimizing investment decisions, the method comprising:
receiving an application from one or more companies in a startup pool;
using artificial intelligence or machine learning to narrow the one or more companies down to one or more startups;
matching the one or more startups with one or more experts in a relevant technical field;
receiving one or more data from the one or more startups about the one or more startups;
transmitting the one or more data to the one or more experts;
receiving one or more analyses from the one or more experts of the one or more startups; and
aggregating the one or more analyses to create a consensus rating for each of the one or more startups.

2. The method of claim 1, further comprising transmitting the one or more analyses and the consensus ratings to one or more investors.

3. The method of claim 1, further comprising receiving one or more evaluations from the one or more investors of the one or more startups.

4. The method of claim 3, further comprising making one or more investment decisions based at least in part on the one or more analyses, the consensus ratings, and/or the one or more evaluations.

5. The method of claim 1, further comprising paying each of the one or more experts for the one or more analyses in the form of investment credit in any of the one or more startups.

6. The method of claim 1, wherein the one or more data comprise one or more of: documents; videos; financial data; financial projections; market data; economic data; industry type; founder identification; founder background; expert identification; expert ratings; investor identification.

7. The method of claim 1, wherein the consensus ratings comprise one or more of: a predicted company valuation; a rating scale of 10.

8. The method of claim 1, wherein the transmitting the one or more data to the one or more experts comprises transmitting via a smart device.

9. The method of claim 4, further comprising improving the one or more investment decisions over time with a machine learning model.

10. A computer implemented method for training a machine learning model for optimizing investment outcomes, the method comprising:
obtaining a dataset of identified investment outcomes;
training the machine learning model using the dataset of identified investment outcomes thereby obtaining a trained machine learning model, and
storing the trained machine learning model.

11. The method of claim 10, further comprising training a machine learning model for optimizing identified investment outcomes, wherein the training comprises;
training the machine learning model using a dataset of one or more identified investment outcomes, thereby obtaining a further trained machine learning model; and
storing the further trained machine learning model.

12. The method of claim 10, wherein the one or more identified investment outcomes comprise one or more of: expert accuracy, return on investment.

13. The method of claim 10, wherein the machine learning model uses one or more inputs comprising one or more of: industry type, founder identification, founder background, expert identification and that expert's ratings, investor identification and success, or other variables.

14. The method of claim 10, further comprising making one or more investment decisions based at least in part on the stored trained machine learning model.

15. The method of claim 11, further comprising making one or more investment decisions based at least in part on the stored further trained machine learning model.

16. A non-transitory computer-readable storage medium having stored thereon instructions executable by processing circuitry to perform any of the steps of claim 1.

17. A system for facilitating knowledge sharing between one or more startups, one or more experts, and one or more investors, and optimizing investment decisions, comprising:
processing circuitry; and
a memory, the memory containing instructions executable by the processing circuitry whereby the system/apparatus is operative to any of the steps of;
receiving an application from one or more companies in a startup pool;
using artificial intelligence or machine learning to narrow the one or more companies down to one or more startups;
matching the one or more startups with one or more experts in a relevant technical field;
receiving one or more data from the one or more startups about the one or more startups;
transmitting the one or more data to the one or more experts;
receiving one or more analyses from the one or more experts of the one or more startups; and
aggregating the one or more analyses to create a consensus rating for each of the one or more startups.

18. The system of claim 17, wherein the steps further comprise transmitting the one or more analyses and the consensus ratings to one or more investors.

19. The system of claim 17, wherein the steps further comprise receiving one or more evaluations from the one or more investors of the one or more startups.

20. The system of claim 17, wherein the steps further comprise making one or more investment decisions based at least in part on the one or more analyses, the consensus ratings, and/or the one or more evaluations.
